(19) United States
(12) Patent Application Publication
(10) Pub. No.: US 2011/0295520 A1
(43) Pub. Date: Dec. 1, 2011

(54) Method and System for Quantitative Cell Nuclei Arrangement Measure in Histological Tissue Using Structural Entropy

(75) Inventors: Eric Cosatto, Red Bank, NJ (US); Christopher D. Malon, Fort Lee, NJ (US); Hans Peter Graf, Lincroft, NJ (US)

(73) Assignee: NEC LABORATORIES AMERICA, INC., Princeton, NJ (US)

(21) Appl. No.: 13/115,562

(22) Filed: May 25, 2011

Related U.S. Application Data
(60) Provisional application No. 61/348,328, filed on May 26, 2010.

(51) Int. Cl. G06F 19/00

(52) U.S. Cl. 702/21

(57) ABSTRACT

A method for measuring structural entropy of cell nuclei in a histological micrograph of a biopsy tissue sample involves the steps of: obtaining a dye color map from a color image of the biopsy tissue sample; locating cell nuclei in the dye color map; and measuring structural features within small groups (cliques or paths) of cell nuclei to determine their degree of organization (or structural entropy). Also, an apparatus for measuring structural entropy of cell nuclei in a histological micrograph of a biopsy tissue sample includes a processor executing instructions for: obtaining a dye color map of the biopsy tissue sample; locating cell nuclei in the dye color map; and measuring structural features within small groups (cliques or paths) of cell nuclei to determine their degree of organization (or structural entropy).

### RELATED APPLICATIONS

This application claims the benefit of U.S. Provisional Application No. 61/348,328, filed May 26, 2010, the entire disclosure of which is incorporated herein by reference.

### FIELD

The present disclosure relates to digital pathology. More particularly, the present disclosure relates to a method and apparatus for analyzing tissue structures by quantitatively measuring tissue cell nuclei arrangements on a digital histological micrograph.

### BACKGROUND

The function of a tissue is determined to a large extent by the arrangement of the cells and pathologists can obtain a lot of information about the functionality and health of a tissue by looking at the structure of cell arrangements. In particular, in the presence of cancer, the cells lose their ability to grow in well organized structures, such as epithelial layers and their arrangements tend to become more random. Such randomness (or structural entropy) is an important diagnostic measure and pathologists are trained to identify cell arrangements as normal, functional tissue or as non-typical and indicative of a disease.

Normal cells tend to form glands or other structures they are programmed to make. In cancer, cells often lose the ability to arrange themselves, thereby creating tumors. The degree at which these tumors lack cell arrangements is a measure of their aggressiveness. This measure is essential to provide adequate treatment to patients, as the more aggressive the tumor, the more aggressive should the treatment be. Precise understanding of the aggressiveness of a tumor is key to better treatment of cancer patients. Heavy chemotherapy and radiotherapy have serious side-effects that can potentially kill a patient. It is essential to be able to dose these treatments so that they kill the tumor and not the patient.

Prior art methods for identifying cell arrangements by computer have mostly focused on gland structures, attempting to identify them by their lumen, i.e., the visible white opening in the center of a gland. However, such methods are not effective in difficult situations where the glands are not well formed or when lumens are not visible. Other methods use edge detectors to identify local gland edges formed by several nuclei. This approach is also ineffective when the glands are not well formed or when they are touching each other.

Accordingly, a method and an apparatus are needed for reliably analyzing cell nuclei arrangements to determine the functionality and health of a tissue.

### SUMMARY

A method is disclosed for quantitatively measuring structural entropy of cell nuclei in biopsy tissue. The method comprises the steps of: obtaining a dye color map of an image of the tissue; locating cell nuclei in the dye color map; and measuring, within small groups of cell nuclei, features that determine their structural entropy or degree of organization.

In some embodiments, the step of measuring statistics of structural arrangement features is performed over cliques of neighboring nuclei.

In some embodiments, one of the features comprises an average distance of a given nuclei to its two closest neighbors.

In some embodiments, one of the features comprises an angle formed by a given nuclei and its two closest neighbors.

In some embodiments, one of the features comprises a number of circular sectors around a given nuclei that contain one or more cell nuclei.

In some embodiments, the step of measuring statistics of structural arrangement features is performed over paths of consecutive nuclei wherein a number of nuclei form each of the paths.

In some embodiments, each of the paths is obtained by the steps of: selecting a first cell nucleus not already belonging to a path; finding a second cell nucleus not already belonging to a path within a predetermined distance range of the first nucleus; and finding a third cell nucleus not already belonging to a path within a predetermined distance range of the second nucleus and also within a predetermined angle of the direction formed by the first and second nuclei; and finding consecutive cell nuclei not already belonging to a path within a predetermined distance range of the preceding nucleus and also within a predetermined angle of the direction formed with the previous nucleus and offset by the angle formed by the latter direction and the direction formed by the previous nucleus and its predecessor in the path, until no existing nuclei not already belonging to a path satisfy those constraints.

In some embodiments, instead of considering one nucleus at each step of the path, a set of candidate nuclei is instead selected; the method further comprising the step of: creating a directed acyclic graph of all possible combinations of nuclei that form the path; assigning a cost value to each transition in the graph based on the distance between the two nuclei as well as the angle formed by their direction; and performing a Viterbi algorithm to find the “best” path generating the lowest cost.

In some embodiments, one of the features comprises a number of nuclei in a path.

In some embodiments, one of the features comprises a curvature of a path.

In some embodiments, one of the features comprises the number of inflexion points or change of sign in the curvature of a path.

In some embodiments, the step of measuring statistics of structural arrangement features is performed over closed paths of consecutive nuclei wherein a number of nuclei forming a path closes onto themselves.

In some embodiments, each of the closed paths is obtained by the steps of: selecting a first cell nucleus not already belonging to a path; finding a second cell nucleus not already belonging to a path within a predetermined distance range of the first nucleus; and finding a third cell nucleus not already belonging to a path within a predetermined distance range of the second nucleus and also within a predetermined angle of the direction formed by the first and second nuclei; finding consecutive cell nuclei not already belonging to a path except for the first nuclei of this path, within a predetermined distance range of the preceding nucleus and also within a predetermined angle of the direction formed with the previous nucleus and offset by the angle formed by the latter direction and the direction formed by the previous nucleus and its predecessor in the path, until either the first nuclei of the path satisfies those constraints or no existing nuclei not already belonging to a path satisfy those constraints; and discarding paths for which the last nucleus is not the first nucleus.

In some embodiments, one of the statistics comprises a normalized histogram.

In some embodiments, one of the statistics comprises a percentile value.

In some embodiments, one of the statistics comprises an average value.

In some embodiments, one of the statistics comprises a standard deviation value.

In some embodiments, one of the statistics comprises the number of groups having certain characteristics.

In some embodiments, one of the statistics comprises the number of groups forming closed paths.

Also disclosed is an apparatus for measuring said structural entropy. The apparatus comprises a processor executing instructions for: obtaining a dye color map of the biopsy tissue sample; locating cell nuclei in the dye color map; and measuring, within small groups of cell nuclei, features that determine their structural entropy (or degree of organization).

### BRIEF DESCRIPTION OF THE DRAWINGS

FIG. 1 is a flowchart of the method for directly measuring the structural entropy of cell nuclei.

FIGS. 2A and 2B diagrammatically illustrate an embodiment of a cliques process.

FIGS. 2C and 2D diagrammatically illustrate other embodiments of the cliques process.

FIGS. 3A-3D diagrammatically illustrate an embodiment of a path process.

FIG. 4 is a block diagram of an exemplary embodiment of a computer system for performing the methods described herein.

### DETAILED DESCRIPTION

When cells begin to lose their ability to form organized structures, their proliferation becomes more random and entropy increases. In the present disclosure, a method is described for directly measuring the structural entropy of cell nuclei. The method identifies different cell nuclei arrangements reliably and provides a powerful tool for locating and evaluating the aggressiveness of cancerous tissues.

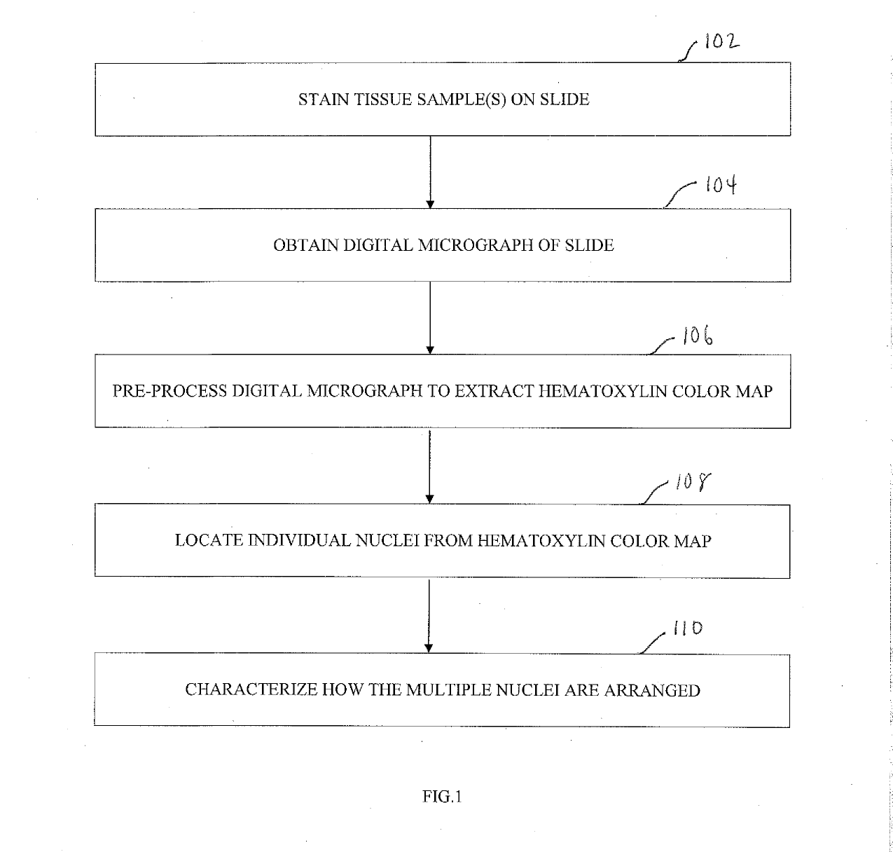

FIG. 1 is a flowchart of the method for directly measuring the structural entropy of cell nuclei. In block 102, a slide containing one or more biopsy tissue samples is prepared by staining the tissue sample(s) with multiple dyes, each of a different color. In one exemplary embodiment, the stains used for staining the biopsy tissue sample(s) can include hematoxylin (a dark magenta colored dye) and eosin (a pinkish colored dye). In the embodiment using Hematoxylin-Eosin (HE) staining, the Hematoxylin stains the nuclear chromatin, while the Eosin stains the cytoplasmic components.

After preparing the slide, a color scan (digital micrograph) of the slide of the stained biopsy tissue sample(s) is obtained with an imaging device in block 104.

In block 106, the digital micrograph is pre-processed to extract a dye (e.g., hematoxylin) color map. Specifically, individual cell nuclei of the tissue sample(s) are identified and located in the digital micrograph of the slide containing stained biopsy tissue. The resolution of the dye stained images is typically above 100K dpi (4.35 pixels per micron). A succession of filters applied at different resolutions is used to progressively “zoom-in” on regions of interest. In this context, regions of interest comprise regions where large nuclei may be present. A first filter, based on luminance, is used to locate the tissue within the slide. A second filter is used to reject pen markings made on the slide to separate the biopsy tissue samples. A third filter is used to reject areas that are out of focus. After filtering, the average dye colors are adaptively found and the original RGB pixels are projected onto each color channel to obtain dye intensity maps.

Because the staining process is a manual operation involving many steps, the amount of staining used or the thickness of the biopsy tissue sample(s) may affect the final visual appearance of the sample(s), and the imaging process (scanning) may be performed on different systems with different types of light sources and may or may not apply color correction, there is a need to find first for each tissue sample the actual dye colors and then normalize the image based on color vectors corresponding to the dyes (H and E vectors in embodiments using HE-staining). The average H and E vectors are determined with the following equations:

$$\overline{H} = \frac{1}{n} {\sum }_{i = 1}^{n} {( 1 - {\overline{P}}_{i}^{R} )}^{4} {\overline{P}}_{i}$$

where P is a RGB pixel and P^{R} is the red component of P; and

$$\overline{E} = \frac{1}{n} {\sum }_{i = 1}^{n} {‖ {\overline{P}}_{i} - ( {\overline{P}}_{i} \cdot \overline{H} ) \overline{H} ‖}^{4} {\overline{P}}_{i} .$$

In block 108, individual nuclei are located from the dye color map that stains the nuclear chromatin (e.g., Hematoxylin in HE-staining embodiments). In one exemplary embodiment, areas containing nuclei are located in the dye color map by running a DoG filter (Difference of Gaussian) over the image. Non-maxima suppression is applied to the resulting map and a list of candidate locations for each nucleus is obtained.

Starting at the previously obtained candidate locations, an Active Contour Algorithm (nuclei finder) is used to find the contours (nuclei). Opposing constraints of elasticity and edge-matching are used to iteratively update the snakes to match the contours of nuclei on the image. Several initial conditions and elastic strengths are used per location, thus producing n·e·i contours, where n is the number of detections in the image, e is the number of different elastic strengths and i is the number of different initializations.

Because of large variations in the appearance of biopsy tissues as well as differences in staining quality, there exist many opportunities for the nuclei finder to produce spurious contours. A typical occurrence of a spurious contour happens when two or more nuclei are clumped together, resulting in one contour encompassing them all. Such spurious contours would easily throw off the statistics of the nuclear area measurements. Fortunately, since there are usually a large number of nuclei in an image, we can afford to ignore those for which the nuclei finder failed to produce a sufficiently trustworthy contour. In order to filter out reliably those spurious contour, a machine-learning approach is used where contours are manually overlaid onto the original digital micrograph. In one embodiment, an interactive graphical interface is used for manually overlaying the contours onto the image. The operator/user simply clicks with a mouse on spurious contours, thus creating a training set of “good” and “spurious” contours to train a classifier to select contours. For the training phase, each contour is encoded into a vector of features. For this task, only features relevant to discriminate between well formed contours that match their underlying image versus spurious contours that do not follow the outline of a nucleus. Hence, a set of features is selected that captures the response of the edge map along the contour; the texture within the contour; the geometry of the contour. Then a classifier, such as Support Vector Machine, is trained to select the contours or nuclei in the color map.

The processes of blocks 102, 104, 106, and 108 are well known in the art, for example, see U.S. Patent Application Publication No. 2009/0297007 A1, entitled Automated Method And System For Nuclear Analysis of Biopsy Images, which is assigned to the assignee herein. The disclosure of U.S. Patent Application Publication No. 2009/0297007 A1, as it pertains to the processes of blocks 102, 104, 106, and 108, is incorporated herein by reference.

In block 110, small groups of the cell nuclei found in block 108, are examined to measure how they are structurally arranged or organized. Micrographs of biopsy tissue typically contain vast amounts of cells. For efficiency reasons, it is therefore essential to restrict structural entropy evaluation to small manageable groups of cells. Once structural features are obtained from those groups of cells, statistics of those features are computed over a region of interest of the tissue. Those statistics represent the structural entropy in that region of the tissue. The present disclosure describes two processes for grouping cell nuclei: cliques and paths. In biology groups or cliques of atoms are sometimes used to characterize proteins and define similarities between molecules. The cliques process of the present disclosure is different, because an individual clique is not used for describing the local properties of the tissue, but instead, a statistical measure over a set of cliques is calculated. The process of forming cliques starts from a given nucleus and adds neighboring nuclei that fit a certain set of constraints. The process of forming paths starts from a nucleus and adds nuclei while trying to form a path with certain directional and shape constraints typical of epithelial layers of glands.

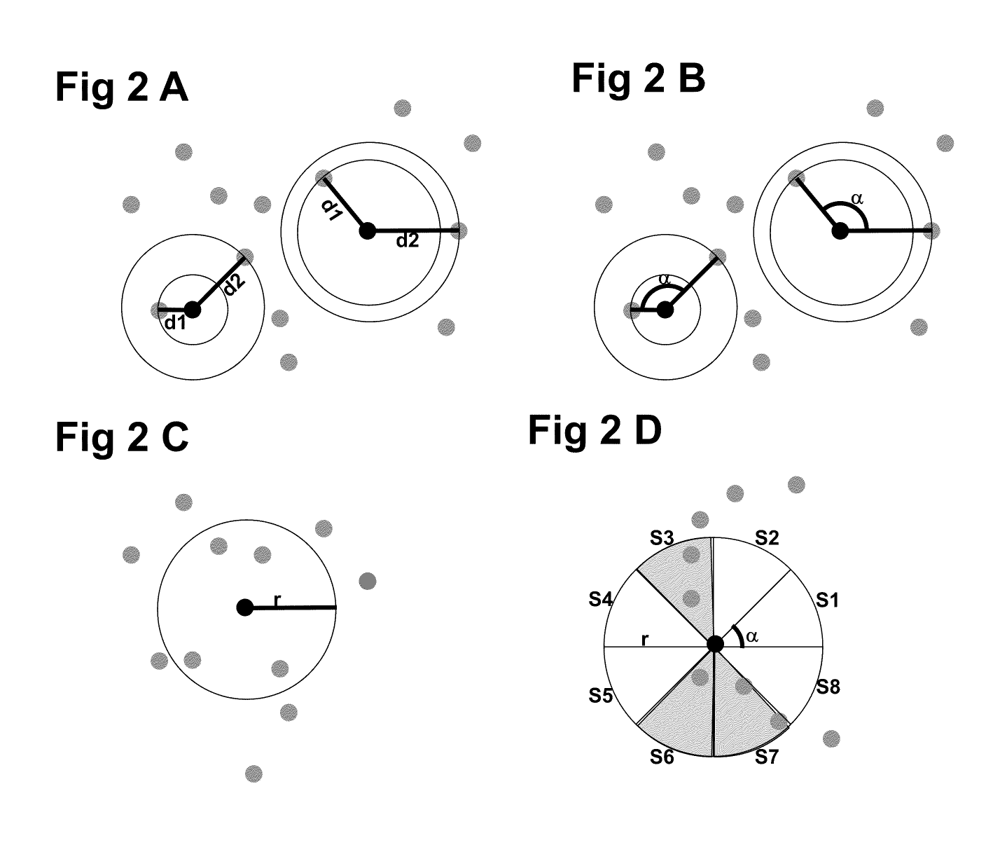

Referring to FIGS. 2A and 2B, an embodiment of the clique process comprises finding, for each nucleus, the two closest nuclei. The two distances d1 and d2 to the closest nuclei are averaged to provide one feature of the clique. Another feature is obtained by taking the absolute value of the difference of d1 and d2. As shown in FIG. 2B, the angle formed by the considered nucleus and its two closest neighbors provides another structural feature of the clique.

Referring to FIG. 2C, another embodiment of the cliques process comprises finding for each nucleus how many nuclei exists within a radius r. The number of cell nuclei within that radius provides a structural feature.

Referring to FIG. 2D, another embodiment of the cliques process comprises first defining, around each nucleus, n circular sectors of radius r and angle α. Then the number of sectors that contain one or more cell nuclei (sectors S3, S6, S7, shown shaded) is used as structural feature.

The path process joins the cell nuclei of a group in a path by selecting a cell nucleus and hopping from cell nucleus to cell nucleus following a given set of constraints. Once the constraints cannot be met anymore, the path construction stops and another cell nucleus is selected as the start point. Many numeric feature values can be derived from these paths. For example, in a given area of the micrograph, the number of paths, the average length of the paths, the average regularity of the paths, the curvature of the paths and the number of inflexion points in the paths are good features. Another feature is the proportion of cell nuclei belonging to such paths.

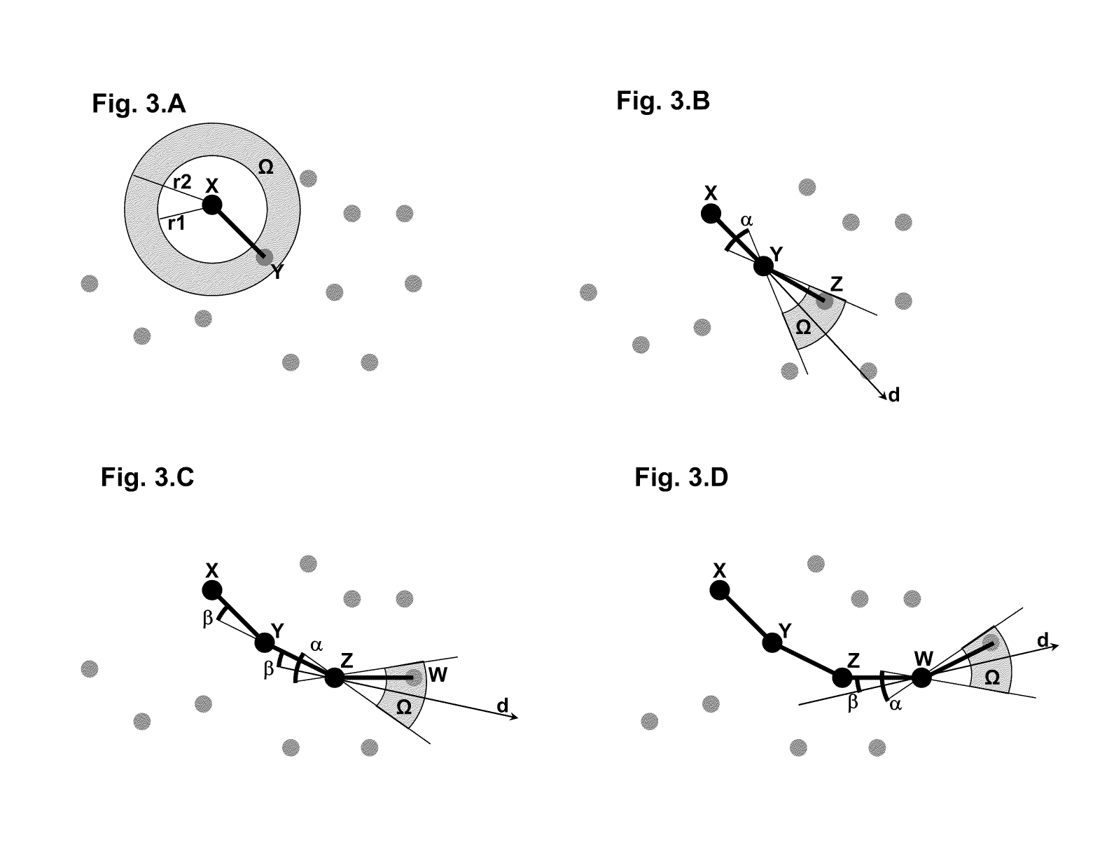

Referring to FIGS. 3A-3D, an embodiment of the path process comprises obtaining a path by combining neighboring cell nuclei into curved lines, mimicking epithelial layers of glands. In FIG. 3A, a first cell nucleus X is selected and a second cell nucleus is searched for in ring area Ω constrained by radii r1 and r2. In this example, the search yields cell nucleus Y. In FIG. 3B, a third cell nucleus is searched for in ring sector area Ω centered on Y and constrained by radii r1 and r2 and angle α centered on the direction d (determined by segment XY). This yields cell nucleus Z. In FIG. 3C, a fourth cell nucleus is searched for in ring area Ω constrained by radii r1 and r2 and angle α centered on the direction d (determined by segment YZ and offset by the angle β, which is the angle formed by segments XY and ZY). This yields cell nucleus W. In FIG. 3D, the method proceeds to find another cell nucleus that is in turn added to the path of cell nuclei. The process terminates when no candidate can be found in the search area. Alternatively the process can be set to terminate only when the initial nucleus of the path can found in the search area. In this case, the process produces closed paths.

An enhancement of this method allows more than one candidate nuclei at each step, thus creating several candidate paths for a given starting cell nucleus. The candidate paths create a directed acyclic graph with edges representing transitions from one cell nucleus to the next. Each edge of the graph is given a cost based on the fitness to the path. A CPU is then programmed with a Viterbi algorithm to find the best path among multiple candidate paths.

Features from cliques and paths are then collected over a certain area of the tissue. Statistics of these features are then extracted to characterize the structure of that tissue area. Such statistics include (but are not limited to) average, standard deviation, percentiles and normalized histograms. Features from cliques and paths can be used individually, combined together or combined with others features to derive a structural measure of the tubularity of a cancer tumor. Tubularity refers to the degree with which cell nuclei arrange in glands (or tubules). If a large proportion of nuclei in a given ROI form paths that are sufficiently long (for example, at least 10 nuclei), then the area can be deemed of high degree of tubularity and should be classified as low probability for cancer. Using cliques statistics would be similar. For example if the histogram of angles (between a considered nuclei and its two closest neighbors) over a given ROI shows a hump around 180 degrees, that would mean that most nuclei are part of a gland (their closest neighbors are to their left and right and not in front or behind). Thus, this ROI shows a high degree of glandularity (or tubularity) and should be classified non-cancer. The diagnosis of cancer/non-cancer can be performed using these features (by themselves or combined with features from other analytics) in a classifier.

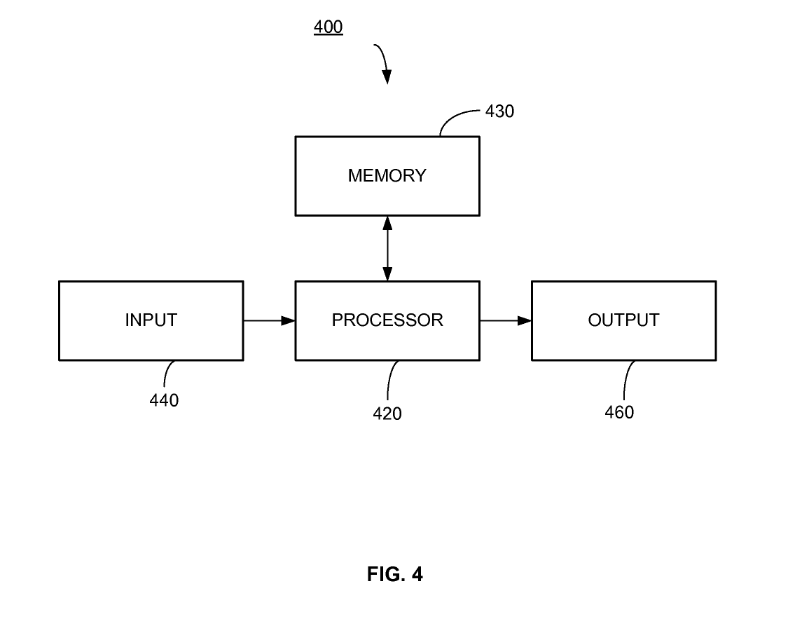

FIG. 4 is a block diagram of an exemplary embodiment of a computer system 400 for implementing the methods described herein. The computer system 400 includes at least one CPU 420, at least one memory 430 for storing one or more programs which are executable by the processor(s) 420 for implementing the methods described herein, one or more inputs 440 for receiving input data, e.g., color scan or image data, etc., and an output 460 for outputting data, e.g., the cliques and paths that have been computed.

In other embodiments of the method and system, the size shape and distribution of chromatin in each nucleus can be determined (prior to the process of block 110) to further improve the characterization of the nuclei arrangements. For example, the cliques and/or paths can be made more reliable by enforcing a constraint that the nuclei of the cliques and/or paths be of similar size and/or shape and/or texture. In addition, the speed of the method and system can be improved by filtering out nuclei of certain sizes and/or shapes and/or textures before extracting cliques.

While exemplary drawings and specific embodiments of the present disclosure have been described and illustrated, it is to be understood that that the scope of the invention as set forth in the claims is not to be limited to the particular embodiments discussed. Thus, the embodiments shall be regarded as illustrative rather than restrictive, and it should be understood that variations may be made in those embodiments by persons skilled in the art without departing from the scope of the invention as set forth in the claims that follow and their structural and functional equivalents.

What is claimed is:

1. A method for measuring structural entropy of cell nuclei in a biopsy tissue sample, the method comprising the steps of:
obtaining, in a computer process, a dye color map of the tissue sample;
locating, in a computer process, cell nuclei in the dye color map; and
measuring, in a computer process, over groups of cell nuclei, statistics of structural arrangement features of cell nuclei.

2. The method of claim 1, wherein the step of measuring statistics of structural arrangement features is performed over cliques of neighboring nuclei.

3. The method of claim 2, wherein one of the features comprises an average distance of a given nuclei to its two closest neighbors.

4. The method of claim 2, wherein one of the features comprises an angle formed by a given nuclei and its two closest neighbors.

5. The method of claim 2, wherein one of the features comprises a number of circular sectors around a given nuclei that contain one or more cell nuclei.

6. The method of claim 1, wherein the step of measuring statistics of structural arrangement features is performed over paths of consecutive nuclei wherein a number of nuclei form each of the paths.

7. The method of claim 6, wherein each of the paths is obtained by the steps of:
selecting a first cell nucleus not already belonging to a path;
finding a second cell nucleus not already belonging to a path within a predetermined distance range of the first nucleus; and
finding a third cell nucleus not already belonging to a path within a predetermined distance range of the second nucleus and also within a predetermined angle of the direction formed by the first and second nuclei; and
finding consecutive cell nuclei not already belonging to a path within a predetermined distance range of the preceding nucleus and also within a predetermined angle of the direction formed with the previous nucleus and offset by the angle formed by the latter direction and the direction formed by the previous nucleus and its predecessor in the path, until no existing nuclei not already belonging to a path satisfy those constraints.

8. The method of claim 7, wherein, instead of considering one nucleus at each step of the path, a set of candidate nuclei is instead selected; the method further comprising the step of:
creating a directed acyclic graph of all possible combinations of nuclei that form the path;
assigning a cost value to each transition in the graph based on the distance between the two nuclei as well as the angle formed by their direction; and
performing a Viterbi algorithm to find the “best” path generating the lowest cost.

9. The method of claim 6, wherein one of the features comprises a number of nuclei in a path.

10. The method of claim 6, wherein one of the features comprises a curvature of a path.

11. The method of claim 6, wherein one of the features comprises the number of inflexion points or change of sign in the curvature of a path.

12. The method of claim 1, wherein the step of measuring statistics of structural arrangement features is performed over closed paths of consecutive nuclei wherein a number of nuclei forming a path closes onto themselves.

13. The method of claim 12, wherein each of the closed paths is obtained by the steps of:
selecting a first cell nucleus not already belonging to a path;
finding a second cell nucleus not already belonging to a path within a predetermined distance range of the first nucleus; and
finding a third cell nucleus not already belonging to a path within a predetermined distance range of the second nucleus and also within a predetermined angle of the direction formed by the first and second nuclei;
finding consecutive cell nuclei not already belonging to a path except for the first nuclei of this path, within a predetermined distance range of the preceding nucleus and also within a predetermined angle of the direction formed with the previous nucleus and offset by the angle formed by the latter direction and the direction formed by the previous nucleus and its predecessor in the path, until either the first nuclei of the path satisfies those constraints or no existing nuclei not already belonging to a path satisfy those constraints; and
discarding paths for which the last nucleus is not the first nucleus.

14. The method of claim 1, wherein one of the statistics comprises a normalized histogram.

15. The method of claim 1, wherein one of the statistics comprises a percentile value.

16. The method of claim 1, wherein one of the statistics comprises an average value.

17. The method of claim 1, wherein one of the statistics comprises a standard deviation value.

18. The method of claim 1, wherein one of the statistics comprises the number of groups having certain characteristics.

19. The method of claim 18, wherein one of the statistics comprises the number of groups forming closed paths.

20. An apparatus for measuring structural entropy of cell nuclei in a biopsy tissue sample, the system comprising:
a processor executing instructions for:
obtaining a dye color map of the tissue sample;
locating cell nuclei in the dye color map; and
measuring over groups of cell nuclei, statistics of structural arrangement features of cell nuclei.
